(19) United States
(12) Patent Application Publication
(10) Pub. No.: US 2012/0031813 A1
(43) Pub. Date: Feb. 9, 2012

(54) Alkoxylated (Meth)Acrylate Polymers and the use Thereof as Crude Oil Demulsifiers

(75) Inventors: Carsten Schaefer, Muehldorf (DE); Carsten Cohrs, Frankfurt (DE); Stefan Dilsky, Altoetting (DE)

(73) Assignee: CLARIANT FINANCE (BVI) LIMITED, Tortola (VG)

(21) Appl. No.: 13/265,471

(22) PCT Filed: Mar. 26, 2010
(86) PCT No.: PCT/EP10/01918

§ 371 Date: Oct. 20, 2011

(30) Foreign Application Priority Data
Apr. 28, 2009 (DE) 10 2009 019 179.8

(51) Int. Cl. C10G 33/04; C08F 20/28

(52) U.S. Cl. 208/188; 526/320

(57) ABSTRACT

The invention relates to the use of copolymers which can be obtained by the polymerization of monomers (A) and (B), (A) being a monomer of formula (I), wherein A represents a C₂ to C₄ alkylene group, B represents a C₂ to C₄ alkylene group different from A, R represents hydrogen or methyl, m is a number from 1 to 500, and n is a number from 1 to 500, and (B) being an ethylenically unsaturated monomer which contains an aliphatic hydrocarbon group, for demulsifying oil/water emulsions in amounts of 0.0001 to 5% by weight, based on the oil content of the emulsion to be demulsified.

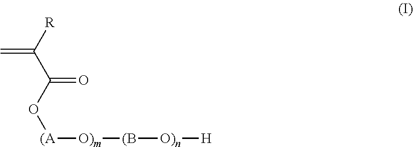

The present invention relates to alkoxylated (meth)acrylate polymers and to the use thereof for breaking water-oil emulsions, especially in crude-oil production.

Crude oil is recovered in the form of an emulsion with water. Before further processing the crude oil, these crude-oil emulsions have to be broken to separate them into the oil portion and the water portion. This is generally done using so-called crude-oil or petroleum emulsion breakers, or else “petroleum breakers” for short. Petroleum breakers are surface-active polymeric compounds capable of effectuating the requisite separation in the emulsion constituents within a short time.

It is mainly alkoxylated alkylphenol-formaldehyde resins, nonionic alkylene oxide block copolymers and also variants crosslinked with bisepoxides that are used as demulsifiers. Overviews are given by “Something Old, Something New: A Discussion about Demulsifiers”, T. G. Balson, pp. 226-238 in Proceedings in the Chemistry in the Oil Industry VIII Symposium, 2003, Manchester, GB, and also “Crude-Oil Emulsions: A State-Of-The-Art Review”, S. Kokal, pp. 5-13, Society of Petroleum Engineers SPE 77497.

U.S. Pat. No. 4,032,514 discloses the use of alkylphenol-aldehyde resins for breaking petroleum emulsions. These resins are obtainable by condensing a para-alkylphenol with an aldehyde, usually formaldehyde.

Such resins are often used in alkoxylated form, as disclosed in DE-A-24 45 873 for example. For this purpose, the free phenolic OH groups are reacted with an alkylene oxide.

In addition to the free phenolic OH groups, free OH groups of alcohols or NH groups of amines can also be alkoxylated, as disclosed in U.S. Pat. No. 5,401,439 for example.

By way of further petroleum emulsion breakers, U.S. Pat. No. 4,321,146 discloses alkylene oxide block copolymers and U.S. Pat. No. 5,445,765 alkoxylated polyethyleneimines. The disclosed breakers can be used as individual components, in mixtures with other emulsion breakers, or else as crosslinked products.

Copolymers of hydrophobic, end group capped and partly crosslinked (meth)acrylates and hydrophilic comonomers as emulsion breakers are disclosed in EP-0 264 841.

The different properties (e.g., asphaltene, paraffin and salt contents, chemical composition of the natural emulsifiers) and water fractions of various crude oils make it imperative to further develop the existing petroleum breakers. Particularly a low dosage rate and broad applicability of the petroleum breaker to be used is at the focus of economic and ecological concern as well as the higher effectivity sought. There is further an increasing need for emulsion breakers as replacements for the controversial alkylphenol-based products.

It is an object of the present invention to develop novel petroleum breakers which are equivalent or superior to the existing alkylphenol-based petroleum breakers in performance, and can be used in even lower doses.

Surprisingly, alkoxylated (meth)acrylate polymers are found to give excellent performance as petroleum breakers at very low dose.

The invention accordingly provides for the use of polymers containing structural units of monomers (A) according to formula I

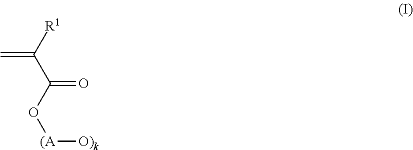

where
A is a C₂ to C₄ alkylene group,
R¹ is hydrogen or methyl,
k is from 1 to 1000,
for breaking oil/water emulsions in amounts of 0.0001% to 5% by weight based on the oil content of the emulsion to be broken.

The invention further provides for the use of polymers containing different structural units of monomers (A) and (B) according to formulae I and II

### (A)

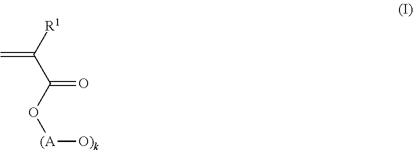

where
A is a C₂ to C₄ alkylene group,
R¹ is hydrogen or methyl,
k is from 1 to 1000,
and

### (B)

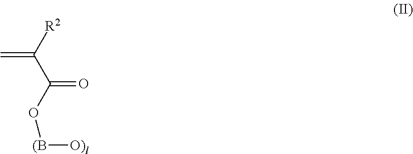

where
B is a C₂ to C₄ alkylene group,
R² is hydrogen or methyl,
l is from 1 to 1000,
for breaking oil/water emulsions in amounts of 0.0001% to 5% by weight based on the oil content of the emulsion to be broken.

The invention further provides polymers containing structural units of monomers (A) according to formula I

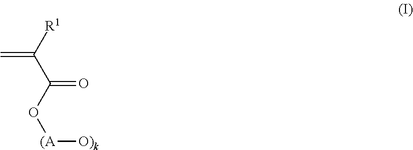

where
A is a C₂ to C₄ alkylene group,
R¹ is hydrogen or methyl,
k is from 1 to 1000,
for breaking oil/water emulsions in amounts of 0.0001% to 5% by weight based on the oil content of the emulsion to be broken.

The invention further provides polymers containing different structural units of monomers (A) and (B) according to formulae I and II

### (A)

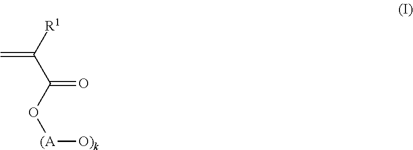

where
A is a C₂ to C₄ alkylene group,
R¹ is hydrogen or methyl,
k is from 1 to 1000,
and

### (B)

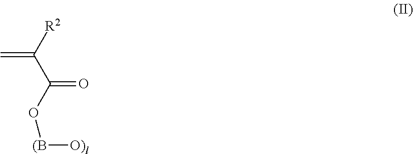

where
B is a C₂ to C₄ alkylene group,
R² is hydrogen or methyl,
l is from 1 to 1000,
for breaking oil/water emulsions in amounts of 0.0001% to 5% by weight based on the oil content of the emulsion to be broken.

The hereinbelow described preferred embodiments of the invention always relate both to the polymers themselves and to their use. This applies irrespective of whether the reference hereinbelow is to the polymers or to their use.

The term that the polymers contain structural units of monomers (A) or (A) and (B) is to be understood as meaning that the polymers are obtainable by polymerization of monomers (A) and (B) when these are subjected to free-radical polymerization.

The polymer according to the invention generally possesses customary terminal groups formed by the initiation of the free-radical polymerization or by chain transfer reactions or by chain termination reactions, for example a proton, a group from a free-radical initiator or a sulfur-containing, for example, group from a chain transfer reagent.

The polymers to be used according to the invention can be homopolymers of monomers of formula I or copolymers of monomers of structural units I and II. In a preferred embodiment, the fractions of structural units of formula I and II sum to 100 mol %.

When the polymers to be used according to the invention are homopolymers, the group -(A-O)ₖ— may be a unitary alkoxy group or a mixed alkoxy group. When it is a mixed alkoxy group, it preferably conforms to the formula -(A¹-O)ₙ-(A²-O)ₘ—,

where
n is from 1 to 500,
m is from 1 to 500,
A¹ is a C₂ to C₄ alkylene group, and
A² is a C₂ to C₄ alkylene group other than A¹.

Preferably, A¹ is a propylene group and A² is an ethylene group. It is further preferable for n to be from 2 to 50. It is further preferable for m to be from 2 to 50. It is further preferable for n+m to be from 2 to 80 and more particularly from 4 to 70. The sequence of the alkoxy groups A¹-O and A²-O can be random or blockwise.

When -(A-O)ₖ— is a unitary alkoxy group, A is preferably a propylene group. k is preferably from 2 to 15 and more particularly from 3 to 10.

When the polymer to be used according to the invention is a copolymer, the monomers of formulae I and II will differ in one or more features. Distinguishing features can be the meanings of R¹ and R², of A and B or of k and l. The monomers can also differ in the sequence of alkoxy units in that this sequence can be blockwise or random.

When the polymers to be used according to the invention are copolymers, the groups -(A-O)ₖ— and —(B—O)ₗ— can be unitary or mixed alkoxy groups. When they are mixed alkoxy groups, they preferably conform to the formulae

-(A¹-O)ₙ-(A²-O)ₘ— and —(B¹—O)ₒ—(B²—O)ₚ—,

where
n is from 1 to 500,
m is from 1 to 500,
o is from 1 to 500,
p is from 1 to 500,
A¹ is a C₂ to C₄ alkylene group,
A² is a C₂ to C₄ alkylene group other than A¹,
B¹ is a C₂ to C₄ alkoxy group, and
B² is a C₂ to C₄ alkoxy group other than B¹.

Preferably, A¹ is a propylene group and A² is an ethylene group. It is further preferable for n to be from 2 to 50. It is further preferable for m to be from 2 to 50. It is further preferable for n+m to be from 2 to 80 and more particularly from 4 to 70.

Preferably, B¹ is a propylene group and B² is an ethylene group. It is further preferable for o to be from 2 to 50. It is further preferable for m to be from 2 to 50. It is further preferable for n+m to be from 2 to 80 and more particularly from 4 to 70.

When -(A-O)ₖ— and —(B—O)ₗ— are unitary alkoxy groups, A is preferably a propylene group and B an ethylene group. k is preferably from 2 to 15 and more particularly from 3 to 10. l is preferably from 2 to 15 and more particularly from 3 to 10.

When -(A-O)ₖ— and —(B—O)ₗ— are unitary alkoxy groups, A is further preferably a propylene group and B a propylene group, where k and l are different. k is preferably from 2 to 15 and more particularly from 3 to 10. l is a number other than k and is preferably from 2 to 15 and more particularly from 3 to 10.

In a preferred embodiment 1, -(A-O)ₖ— is a block of ethylene oxide units and —(B—O)ₗ— is a block of propylene oxide units, where k and l are different. k is preferably from 5 to 80. l is a number other than k and is preferably from 5 to 80.

In a further preferred embodiment 1, -(A-O)ₖ— is a block of propylene oxide units and —(B—O)ₗ— is a block of propylene oxide units. k is preferably from 5 to 80. l is preferably from 5 to 80.

The molar fraction of monomers in the preferred embodiment 1 is from 0.1 to 99.9% for monomer (A) and from 0.1 to 99.9% for monomer (B), more particularly from 1 to 95% for monomer (A) and from 5 to 99% for monomer (B) and specifically from 10 to 90% for monomer (A) and from 10 to 90% for monomer (B).

In a further preferred embodiment (embodiment 2) of the polymer of monomers (A) and (B), (A¹-O)ₘ is a block of propylene oxide units and (A²-O)ₙ is a block of ethylene oxide units, or (A¹-O)ₘ is a block of ethylene oxide units and (A²-O)ₙ is a block of propylene oxide units, where the molar fraction of ethylene oxide units is preferably from 30 to 98%, more particularly from 50 to 95% and more preferably from 60 to 93%, based on the sum total (100%) of the ethylene oxide and propylene oxide units. (B¹—O)ₒ and (B²—O)ₚ are each a block of ethylene oxide units, or preferably a block of propylene oxide units.

m is preferably from 2 to 50.

n is preferably from 2 to 50.

The sum total of o and p is preferably from 2 to 80.

The molar fraction of monomers in the preferred embodiment 2 is from 1 to 99% for monomer (A) and from 1 to 99% for monomer (B), more particularly from 5 to 95% for monomer (A) and from 5 to 95% for monomer (B) and specifically from 10 to 90% for monomer (A) and from 10 to 90% for monomer (B). The monomers (A) and (B) add up to 100 mol %.

In the case of different alkylene oxide units (A¹-O)ₘ, (A²-O)ₙ, in monomer (A) as per embodiment 2 these can be present either in a random arrangement or, as in the case of a preferred embodiment in a block type arrangement.

In a further preferred embodiment (embodiment 3) of the polymer of monomers (A) and (B), (A¹-O)ₘ is a block of propylene oxide units and (A²-O)ₙ is a block of ethylene oxide units, or (A¹-O)ₘ is a block of ethylene oxide units and (A²-O)ₙ is a block of propylene oxide units, where the molar fraction of ethylene oxide units is preferably from 30 to 98%, more particularly from 50 to 95% and more preferably from 60 to 93%, based on the sum total (100%) of ethylene oxide and propylene oxide units, and (B¹—O)ₒ is a block of propylene oxide units and (B²—O)ₚ is a block of ethylene oxide units, or (B¹—O)ₒ is a block of ethylene oxide units and (B²—O)ₚ is a block of propylene oxide units, where the molar fraction of ethylene oxide units is preferably from 30 to 98%, more particularly from 50 to 95% and more preferably from 60 to 93%, based on the sum total (100%) of ethylene oxide and propylene oxide units.

The molar fraction of monomers in the preferred embodiment 3 is from 1 to 99% for monomer (A) and from 1 to 99% for monomer (B), more particularly from 5 to 95% for monomer (A) and from 5 to 95% for monomer (B) and specifically from 10 to 90% for monomer (A) and from 10 to 90% for monomer (B). The monomers (A) and (B) add up to 100 mol %.

m is preferably from 2 to 50.

n is preferably from 2 to 50.

o is preferably from 2 to 50.

p is preferably from 2 to 50.

The number of alkylene oxide units (n+m) is preferably from 2 to 500, more particularly from 4 to 100 and more preferably from 5 to 80.

The number of alkylene oxide units (o+p) is preferably from 2 to 500, more particularly from 4 to 100 and more preferably from 5 to 80.

In the case of different alkylene oxide units (A¹-O)ₘ, (A²-O)ₙ, in monomer (A) as per embodiment 3 these can be present either in a random arrangement or, as in the case of a preferred embodiment in a block type arrangement.

In the case of different alkylene oxide units (B¹—O)ₒ, (B²—O)ₚ in monomer (B) as per embodiment 3 these can be present either in a random arrangement or, as in the case of a preferred embodiment in a block type arrangement.

The polymers according to the invention have a number average molecular weight of preferably from 10³ g/mol to 10⁹ g/mol, more preferably from 10³ to 10⁷ g/mol and more particularly from 10³ to 10⁶ g/mol.

The polymers according to the invention are obtainable via free-radical polymerization. The polymerization reaction can be carried out continuously, batchwise or semi-continuously.

The polymerization reaction is preferably carried out as a precipitation polymerization, emulsion polymerization, solution polymerization, bulk polymerization or gel polymerization. Solution polymerization is particularly advantageous for the performance profile of the polymers according to the invention.

Useful solvents for the polymerization reaction include all organic or inorganic solvents that behave very substantially inertly with respect to free-radical polymerization reactions, examples being ethyl acetate, n-butyl acetate or 1-methoxy-2-propyl acetate, and also alcohols such as, for example ethanol, isopropanol, n-butanol, 2-ethylhexanol or 1-methoxy-2-propanol, and also diols such as ethylene glycol and propylene glycol. It is also possible to use ketones such as acetone, butanone, pentanone, hexanone and methyl ethyl ketone, alkyl esters of acetic, propionic and butyric acids such as, for example, ethyl acetate, butyl acetate and amyl acetate, ethers such as tetrahydrofuran, diethyl ether and ethylene glycol monoalkyl ether, ethylene glycol dialkyl ether, polyethylene glycol monoalkyl ether, polyethylene glycol dialkyl ether. It is similarly possible to use aromatic solvents such as, for example, toluene, xylene or higher-boiling alkylbenzenes. It is likewise conceivable to use solvent mixtures, in which case the choice of solvent or solvents depends on the planned use of the polymer according to the invention. Preference is given to using water; lower alcohols; preferably methanol, ethanol, propanols, isobutanol, sec-butanol, t-butanol, 2-ethylhexanol, butylglycol and butyldiglycol, more preferably isopropanol, t-butanol, 2-ethylhexanol, butylglycol and butyldiglycol; hydrocarbons of 5 to 30 carbon atoms and mixtures and emulsions thereof.

The polymerization reaction is preferably carried out in the temperature range between 0 and 180° C. and more preferably between 10 and 100° C., not only at atmospheric pressure but also under elevated or reduced pressure. Optionally, the polymerization can also be carried out under a protective gas atmosphere, preferably under nitrogen.

The polymerization can be initiated using high-energy electromagnetic rays, mechanical energy or the customary, chemical polymerization initiators such as organic peroxides, e.g., benzoyl peroxide, tert-butyl hydroperoxide, methyl ethyl ketone peroxide, cumoyl peroxide, dilauroyl peroxide (DLP) or azo initiators, for example azobisisobutyronitrile (AIBN), azobisamidopropyl hydrochloride (ABAH) and 2,2′-azobis(2-methylbutyronitrile) (AMBN). It is likewise possible to use inorganic peroxy compounds, for example (NH₄)₂S₂O₈, K₂S₂O₈ or H₂O₂, optionally combined with reducing agents (e.g., sodium hydrogensulfite, ascorbic acid, iron(II) sulfate) or redox systems which contain an aliphatic or aromatic sulfonic acid (e.g., benzenesulfonic acid, toluenesulfonic acid) as reducing component.

The usual compounds are used as chain transfer agents. Suitable known CTAs include for example alcohols, such as methanol, ethanol, propanol, isopropanol, n-butanol, sec-butanol and amyl alcohols, aldehydes, ketones, alkylthiols, for example dodecylthiol and tert-dodecylthiol, thioglycolic acid, isooctyl thioglycolate and some halogen compounds, for example carbon tetrachloride, chloroform and methylene chloride.

A preferred aspect of the present invention is the use of the alkoxylated (meth)acrylate polymers as breakers for oil/water emulsions in petroleum recovery.

When used as petroleum breakers, the alkoxylated (meth)acrylate polymers are added to the water-in-oil emulsions, preferably in solution. Alcoholic solvents are preferred for the alkoxylated (meth)acrylate polymers. The alkoxylated (meth)acrylate polymers are used in amounts of 0.0001% to 5%, preferably 0.0005% to 2%, especially 0.0008% to 1% and specifically 0.001% to 0.1% by weight, based on the oil content of the emulsion to be broken.

### EXAMPLES

### General Method of Polymerization

### Homopolymer of Monomer A

A flask equipped with stirrer, reflux condenser, internal thermometer and nitrogen inlet was initially charged with the monomer A and optionally the chain transfer agent in solvent under an incoming flow of nitrogen. Then, under agitation, the temperature was raised to 80° C. and a solution of the initiator was metered during one hour. This was followed by a further 5 hours of stirring at that temperature. The molar mass of the polymer was analyzed via GPC (reference: polyethylene glycol). The yield is >95%.

### General Method of Polymerization

### Polymer of Monomers A and B

A flask equipped with stirrer, reflux condenser, internal thermometer and nitrogen inlet was initially charged with the monomer A, monomer B and optionally the chain transfer agent in solvent under an incoming flow of nitrogen. Then, under agitation, the temperature was raised to 80° C. and a solution of the initiator was metered during one hour. This was followed by a further 5 hours of stirring at that temperature. The molar mass of the polymer was analyzed via GPC (reference: polyethylene glycol). The yield is >95%.

The tables which follow contain synthesis examples in which the polymers were obtained according to the general method of synthesis.

TABLE 1
Examples of homopolymers:

| Example | % by weight of monomer A (MW) |
|---|---|
| 1 | 50 (350) |
| 2 | 50 (750) |
| 3 | 50 (1000) |

monomer (A): -(A¹-O)ₖ - = propenyloxy
MW = average molecular weight
CTA = dodecanethiol

TABLE 2
Examples of polymers as per embodiment 1:

| | % by weight of monomer A | % by weight of monomer B |
|---|---|---|
| Example | (MW) | (MW) |
| 4 | 50 (350) | 50 (750) |
| 5 | 50 (350) | 50 (1000) |
| 6 | 50 (750) | 50 (1000) |
| 7 | 50 (1000) | 50 (2000) |

monomer (A): (A¹-O)ₘ = (A²-O)ₙ = propenyloxy
monomer (B): (B¹-O)ₒ = (B²-O)ₚ = propenyloxy
MW = average molecular weight
CTA = dodecanethiol

TABLE 3
Example of polymers as per embodiment 2:

| | | | % by weight of monomer | % by weight of monomer |
|---|---|---|---|---|
| Example | m | n | A (MW) | B (MW) |
| 8 | 2 | 3 | 10 (350) | 90 (350) |
| 9 | 2 | 3 | 30 (350) | 70 (350) |
| 10 | 2 | 3 | 50 (350) | 50 (350) |
| 11 | 2 | 3 | 70 (350) | 30 (350) |
| 12 | 2 | 3 | 90 (350) | 10 (350) |
| 13 | 2 | 3 | 10 (350) | 90 (750) |
| 14 | 2 | 3 | 30 (350) | 70 (750) |
| 15 | 2 | 3 | 50 (350) | 50 (750) |
| 16 | 2 | 3 | 70 (350) | 30 (750) |
| 17 | 2 | 3 | 90 (350) | 10 (750) |
| 18 | 2 | 3 | 10 (350) | 90 (1000) |
| 19 | 2 | 3 | 30 (350) | 70 (1000) |
| 20 | 2 | 3 | 50 (350) | 50 (1000) |
| 21 | 2 | 3 | 70 (350) | 30 (1000) |
| 22 | 2 | 3 | 90 (350) | 10 (1000) |
| 23 | 2 | 3 | 10 (350) | 90 (2000) |
| 24 | 2 | 3 | 30 (350) | 70 (2000) |
| 25 | 2 | 3 | 50 (350) | 50 (2000) |
| 26 | 2 | 3 | 70 (350) | 30 (2000) |
| 27 | 2 | 3 | 90 (350) | 10 (2000) |
| 28 | 2 | 13 | 10 (750) | 90 (2000) |
| 29 | 2 | 13 | 30 (750) | 70 (2000) |
| 30 | 2 | 13 | 50 (750) | 50 (2000) |
| 31 | 2 | 13 | 70 (750) | 30 (2000) |
| 32 | 2 | 13 | 90 (750) | 10 (2000) |
| 33 | 5 | 9 | 10 (750) | 90 (2000) |
| 34 | 5 | 9 | 30 (750) | 70 (2000) |
| 35 | 5 | 9 | 50 (750) | 50 (2000) |
| 36 | 5 | 9 | 70 (750) | 30 (2000) |
| 37 | 5 | 9 | 90 (750) | 10 (2000) |

m = average number of monomer units (A¹-O)ₘ
n = average number of monomer units (A²- O)ₙ
monomer (A): (A¹-O)ₘ = propenyloxy, (A²-O)ₙ = ethenyloxy
monomer (B): (B¹-O)ₒ = (B²-O)ₚ = propenyloxy
MW = average molecular weight
CTA = dodecanethiol

TABLE 4
Example of polymers as per embodiment 3:

| | | | | | % by weight of | % by weight of |
|---|---|---|---|---|---|---|
| | | | | | monomer A | monomer B |
| Example | m | n | o | p | (MW) | (MW) |
| 38 | 2 | 3 | 2 | 13 | 30 (350) | 70 (750) |
| 39 | 2 | 3 | 2 | 13 | 50 (350) | 50 (750) |
| 40 | 2 | 3 | 2 | 13 | 70 (350) | 30 (750) |
| 41 | 2 | 3 | 5 | 9 | 30 (350) | 70 (750) |
| 42 | 2 | 3 | 5 | 9 | 50 (350) | 50 (750) |
| 43 | 2 | 3 | 5 | 9 | 70 (350) | 30 (750) |
| 44 | 5 | 9 | 2 | 13 | 30 (750) | 70 (750) |
| 45 | 5 | 9 | 2 | 13 | 50 (750) | 50 (750) |
| 46 | 5 | 9 | 2 | 13 | 70 (750) | 30 (750) |

m = average number of monomer units (A¹-O)ₘ
n = average number of monomer units (A²-O)ₙ
o = average number of monomer units (B¹-O)ₒ
p = average number of monomer units (B²-O)ₚ
monomer (A): (A¹-O)ₘ = propenyloxy, (A²-O)ₙ = ethenyloxy
monomer (B): (B¹-O)ₒ = propenyloxy, (B²-O)ₚ = ethenyloxy
MW = average molecular weight
CTA = dodecanethiol

### Determination of Breaking Efficacy of Petroleum Emulsion Breakers

Emulsion breaker efficacy was determined by determining water separation from a crude-oil emulsion per unit time and also the dehydration of the oil. To this end, breaker glasses (conically tapered, graduated glass bottles closeable with a screw top lid) were each filled with 100 ml of the crude-oil emulsion, a defined amount of the emulsion breaker was in each case added with a micropipette just below the surface of the oil emulsion, and the breaker was mixed into the emulsion by intensive shaking. Thereafter, the breaker glasses were placed in a temperature control bath (50° C.) and water separation was tracked.

On completion of emulsion breaking, samples of the oil was taken from the top part of the breaker glass (top oil) and the water content thereof determined according to Karl Fischer. In this way, the novel breakers were assessed in terms of water separation and also oil dehydration.

### Breaking Effect of Breakers Described

Origin of crude-oil emulsion: Hebertshausen, Germany
Water content of emulsion: 48%
Demulsifying temperature: 50° C.

The efficacy of the alkoxylated (meth)acrylate polymers as emulsion breakers compared with Dissolvan® V 5022-1c (a polyamine alkoxylate) at different dose rates is shown in the following tables:

TABLE 5
Efficacy as breaker

| | | | | | | | | | water |
|---|---|---|---|---|---|---|---|---|---|
| | Polymer of: | | | | | | | | in |
| | | Dose | | | | | | | top |
| Exam- | Exam- | rate | time [min] | | | | | | oil |
| ple | ple | [ppm] | 10 | 20 | 30 | 45 | 60 | 120 | [%] |
| 47 | 2 | 40 | 5 | 22 | 25 | 30 | 30 | 39 | 0.5 |
| 48 | 3 | 40 | 0 | 0 | 2 | 9 | 20 | 28 | 1 |
| 49 | 13 | 40 | 8 | 20 | 24 | 28 | 30 | 36 | 1 |
| 50 | 15 | 40 | 1 | 19 | 30 | 34 | 35 | 38 | 1 |
| 51 | 17 | 40 | 0 | 0 | 0 | 4 | 12 | 32 | 0 |
| 52 | 18 | 40 | 3 | 20 | 22 | 26 | 30 | 32 | 0 |
| 53 | 19 | 40 | 15 | 20 | 24 | 30 | 32 | 32 | 1 |
| 54 | 20 | 40 | 1 | 10 | 25 | 32 | 32 | 36 | 1 |
| 55 | 38 | 40 | 0 | 2 | 8 | 18 | 29 | 35 | 0 |
| 56 | 41 | 40 | 0 | 0 | 5 | 11 | 18 | 33 | 0.5 |
| 57 | Dissolvan | 40 | 0 | 0 | 4 | 11 | 19 | 30 | 0 |
| (comp.) | V 5022-1c. | | | | | | | | |

TABLE 6
Efficacy as breaker

| | | | | | | | | | water |
|---|---|---|---|---|---|---|---|---|---|
| | Polymer of: | | | | | | | | in |
| | | Dose | | | | | | | top |
| Exam- | Exam- | rate | time [min] | | | | | | oil |
| ple | ple | [ppm] | 10 | 20 | 30 | 45 | 60 | 120 | [%] |
| 58 | 1 | 125 | 0 | 3 | 20 | 27 | 30 | 40 | 5 |
| 59 | 8 | 125 | 0 | 1 | 2 | 11 | 20 | 34 | 6 |
| 60 | 9 | 125 | 0 | 0.5 | 1 | 2.5 | 5 | 26 | 7 |
| 61 | 10 | 125 | 0 | 0 | 0 | 1 | 2 | 7 | 0 |
| 62 | Dissolvan | 125 | 0 | 3 | 4 | 5 | 7 | 15 | 0 |
| (comp.) | V 5022-1c. | | | | | | | | |

1. A process for breaking an oil/water emulsion comprising the step of adding at least one homopolymer consisting of structural units of at least one monomer (A) according to formula I 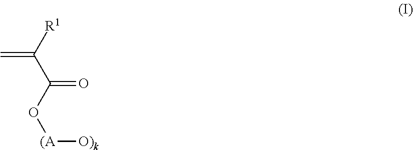
wherein
A is a C₂ to C₄ alkylene group,
R¹ is hydrogen or methyl,
k is from 1 to 1000,
in amounts of 0.0001% to 5% by weight based on the oil content of the emulsion to be broken to the emulsion to be broken.

2. A process for breaking an oil/water emulsion comprising the step of adding at least one polymer containing structural units of monomers (A) and (B) according to formulae I and II which sum to 100 mol %
(A) 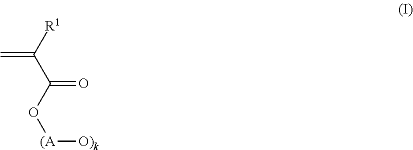
wherein
A is a C₂ to C₄ alkylene group,
R¹ is hydrogen or methyl,
k is from 1 to 1000,
and
(B) 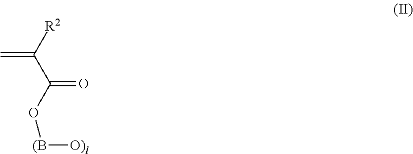
wherein
B is a C₂ to C₄ alkylene group,
R² is hydrogen or methyl,
l is from 1 to 1000,
in amounts of 0.0001% to 5% by weight based on the oil content of the emulsion to be broken to the emulsion to be broken.

3. A process according to claim 1 wherein the group -(A-O)ₖ— is a mixed alkoxy group of the formula -(A¹-O)ₘ-(A²-O)ₙ—,
wherein
n is from 1 to 500,
m is from 1 to 500,
A¹ is a C₂ to C₄ alkylene group, and
A² is a C₂ to C₄ alkylene group other than A¹.

4. A process according to claim 1 wherein A is a propylene group.

5. A process according to claim 2 wherein A is a propylene group, B is a propylene group and k and l are different.

6. A process according to claim 2 wherein -(A-O)ₖ— is a mixed alkoxy group of the formula -(A¹-O)ₘ-(A²-O)ₙ— and B is a propylene group, wherein
n is from 1 to 500,
m is from 1 to 500,
A¹ is a C₂ to C₄ alkylene group, and
A² is a C₂ to C₄ alkylene group other than A¹.

7. A process according to claim 2 wherein -(A-O)ₖ— is a mixed alkoxy group of the formula -(A¹-O)ₘ-(A²-O)ₙ— and —(B—O)ₗ— is a mixed alkoxy group of the formula —(B¹—O)ₒ—(B²—O)ₚ—,
wherein
n is from 1 to 500,
m is from 1 to 500,
o is from 1 to 500,
p is from 1 to 500,
A¹ is a C₂ to C₄ alkylene group,
A² is a C₂ to C₄ alkylene group other than A¹,
B¹ is a C₂ to C₄ alkoxy group, and
B² is a C₂ to C₄ alkoxy group other than B¹.

8. A process according to claim 3 wherein (n+m) is from 2 to 80.

9. A process according to claim 7 wherein (o+p) is from 2 to 80.

10. A process according to claim 2, wherein the number average molecular weight of the polymer is from 10³ to 10⁹ g/mol.

11. A process according to claim 2, wherein the fraction of monomers A according to formula I is from 0.1% to 99% by weight.

12. A process according to claim 2, wherein the fraction of monomers B is from 0.1 to 99 mol %.

13. A process according to claim 3, wherein the alkoxy groups are arranged blockwise.

14. A process according to claim 2, wherein (A¹-O)ₘ is a block of propylene oxide units and (A²-O)ₙ is a block of ethylene oxide units, or (A¹-O)ₘ is a block of ethylene oxide units and (A²-O)ₙ is a block of propylene oxide units, and wherein the molar fraction of ethylene oxide units, based on the sum total of ethylene oxide and propylene oxide units, is from 30 to 98%.

15. A homopolymer containing structural units of at least one monomer (A) according to formula I which sum to 100 mol % 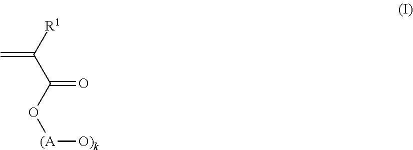
wherein
A is a C₂ to C₄ alkylene group,
R¹ is hydrogen or methyl, and
k is from 1 to 1000.

16. A polymer containing different structural units of monomers (A) and (B) according to formulae I and II which sum to 100 mol %
(A) 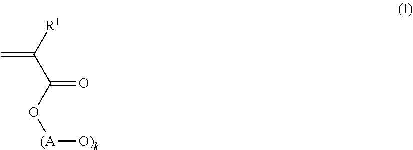
wherein
A is a C₂ to C₄ alkylene group,
R¹ is hydrogen or methyl,
k is from 1 to 1000,
and
(B) 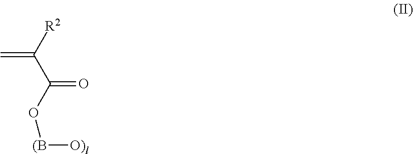
wherein
B is a C₂ to C₄ alkylene group,
R² is hydrogen or methyl,
l is from 1 to 1000.

17. A process according to claim 7 wherein (n+m) is from 2 to 80.

18. A process according to claim 1, wherein the number average molecular weight of the homopolymer is from 10³ to 10⁹ g/mol.
